(19) United States
(12) Patent Application Publication
(10) Pub. No.: US 2015/0256044 A1
(43) Pub. Date: Sep. 10, 2015

(54) SPINDLE MOTOR AND HARD DISK DRIVE INCLUDING THE SAME

(71) Applicant: SAMSUNG ELECTRO-MECHANICS CO., LTD., Suwon-si (KR)

(72) Inventor: Ho Kyung JANG, Suwon-si (KR)

(73) Assignee: SAMSUNG ELECTRO-MECHANICS CO., LTD., Suwon-si (KR)

(21) Appl. No.: 14/632,372

(22) Filed: Feb. 26, 2015

(30) Foreign Application Priority Data
Mar. 10, 2014 (KR) 10-2014-0027643

(51) Int. Cl. H02K 5/167; H02K 1/27; G11B 19/20

(52) U.S. Cl. CPC H02K 5/1677; G11B 19/2009; H02K 1/2786

(57) ABSTRACT

There are provided a spindle motor and a hard disk drive including the same. The spindle motor includes: a lower thrust member fixed to a base member; a shaft fixed to the base member; a sleeve rotatably installed on the shaft; a rotor hub coupled to the sleeve; and an upper thrust member fixed to an upper end portion of the shaft, wherein the sleeve includes a circulation hole formed therein, an upper auxiliary pressure bearing is formed between the upper thrust member and the rotor hub facing each other in a radial direction, a lower auxiliary pressure bearing is formed between the lower thrust member and the sleeve facing each other in the axial direction, and pressure formed in the lubricating fluid by the upper auxiliary pressure bearing is higher than pressure formed in the lubricating fluid by the lower auxiliary pressure bearing.

### CROSS-REFERENCE TO RELATED APPLICATION

This application claims the priority and benefit of Korean Patent Application No. 10-2014-0027643 filed on Mar. 10, 2014, with the Korean Intellectual Property Office, the disclosure of which is incorporated herein by reference.

### BACKGROUND

The present disclosure relates to a spindle motor and a hard disk drive including the same, and more particularly, to a structure capable of significantly decreasing leakage of a fluid in a fixed shaft type spindle motor.

A fixed shaft type spindle motor in which a shaft having excellent vibration characteristics is fixed to a casing of a hard disk drive for a server is generally mounted in an information recording and reproducing device such as a hard disk drive, or the like.

That is, the shaft is fixedly installed in the spindle motor mounted in the hard disk drive for a server in order to prevent information recorded on a disk from being damaged and the disk becoming unrecordable/unreadable due to a large amplitude in a rotor caused by external vibrations.

In the case in which the fixed type shaft is installed as described above, several liquid-vapor interfaces are generally formed in order to configure a hydrodynamic bearing assembly filled with a lubricating fluid. However, such liquid-vapor interfaces are affected by dynamic grooves during rotation to thereby be moved. When the movement of the liquid-vapor interfaces is not appropriately controlled, there is a problem that the lubricating fluid may be leaked.

When an amount of lubricating fluid injected into a bearing is decreased in order to prevent the leakage of the lubricating fluid, there is a problem that a lifespan of the spindle motor is decreased due to evaporation of the lubricating fluid. In order to solve this problem, the development of a structure capable of retaining a sufficient amount of the lubricating fluid has been urgently demanded.

The following Related Art Document (Korean Patent Laid-Open Publication No. 10-2013-0035395) discloses a structure for solving the above-mentioned problem. However, since auxiliary dynamic grooves are provided between surfaces of an upper thrust member and a sleeve in an axial direction, in the case in which a rotating member is rotated in a state in which floatation thereof occurs, an interval is continuously changed depending on several variables, such that a pumping effect may not be substantially implemented, thereby deteriorating performance.

### RELATED ART DOCUMENT

(Patent Document 1) Korean Patent Laid-Open Publication No. 10-2013-0035395

### SUMMARY

An aspect of the present disclosure may provide a spindle motor capable of sufficiently storing a lubricating fluid without leakage of the lubricating fluid. That is, an aspect of the present disclosure may provide a spindle motor capable of suppressing deteriorations in performance of a dynamic bearing assembly by intentionally including a sealing part having a large volume so as to store a sufficient amount of lubricating fluid to allow the lubricating fluid to be sufficiently stored.

An aspect of the present disclosure may also provide a spindle motor including an auxiliary pumping groove so that a lubricating fluid may move to a sealing part having a large volume when the spindle motor operates, that is, when a rotating member such as a sleeve, a rotor, and the like, is rotated.

Aspects of the present disclosure are not limited thereto, but may be variously implemented by exemplary embodiments of the present disclosure to be described below.

According to an aspect of the present disclosure, a spindle motor may include: a lower thrust member fixed to abase member; a shaft fixed to at least one of the lower thrust member and the base member; a sleeve disposed above the lower thrust member to form, together with the lower thrust member, a liquid-vapor interface of a lubricating fluid, thereby forming a lower sealing part, and rotatably installed on the shaft; a rotor hub coupled to the sleeve to thereby be rotated together with the sleeve; and an upper thrust member fixed to an upper end portion of the shaft and forming, together with the sleeve, a liquid-vapor interface of a lubricating fluid, thereby forming an upper sealing part, wherein the sleeve includes a circulation hole formed therein so as to allow upper and lower surfaces thereof in an axial direction to be in communication with each other, an upper auxiliary pumping groove is formed in any one of surfaces of the upper thrust member and the rotor hub facing each other in a radial direction, a lower auxiliary pumping groove is formed in any one of surfaces of the lower thrust member and the sleeve facing each other in the axial direction, and pressure formed in the lubricating fluid by the upper auxiliary pumping groove is higher than pressure formed in the lubricating fluid by the lower auxiliary pumping groove.

A volume of the lubricating fluid may be larger in the lower sealing part than in the upper sealing part.

The lower auxiliary pumping groove may be formed in an outer portion of the circulation hole in the radial direction.

Surfaces of the upper thrust member in which the upper auxiliary pumping groove is formed and the rotor hub, facing each other in the radial direction, may have a labyrinth seal formed therebetween.

A thrust dynamic groove may be formed in at least one of a lower surface of the upper thrust member and the upper surface of the sleeve or at least one of an upper surface of the lower thrust member and the lower surface of the sleeve.

The rotor hub may include: a rotor hub body provided with an insertion portion into which the upper thrust member is inserted; a mounting part extended from an edge of the rotor hub body and having a magnet assembly mounted on an inner surface thereof; and an extension part extended from a distal end of the mounting part in an outer diameter direction.

The sleeve and the rotor hub may be integrally formed with each other.

An outer surface, in the radial direction, of the sleeve facing the lower thrust member in the radial direction may be inclined in an inner diameter direction upwardly in an axial direction.

A portion above a portion at which the labyrinth seal is formed in an outer surface, in the radial direction, of the upper thrust member facing the rotor hub in the radial direction may be inclined in an inner diameter direction upwardly in the axial direction.

The shaft and the upper thrust member may be integrally formed with each other.

A depth of the upper auxiliary pumping groove may be shallower than that of the lower auxiliary pumping groove.

An interval between the surfaces of the upper thrust member and the rotor hub facing each other in the radial direction may be smaller than an interval between the surfaces of the lower thrust member and the sleeve facing each other in the axial direction.

According to another aspect of the present disclosure, a hard disk drive may include: the spindle motor as described above rotating a disk by power applied thereto through a substrate; a magnetic head writing data to and reading data from the disk; and a head transfer part moving the magnetic head to a predetermined position on the disk.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is an enlarged view of part A of FIG. 1;

FIG. 3 is a partially cut-away exploded perspective view showing a sleeve and upper and lower thrust members according to an exemplary embodiment of the present disclosure; and

FIG. 4 is a schematic cross-sectional view showing a recording disk driving device having the spindle motor according to an exemplary embodiment of the present disclosure mounted therein.

### DETAILED DESCRIPTION

Exemplary embodiments of the present disclosure will now be described in detail with reference to the accompanying drawings.

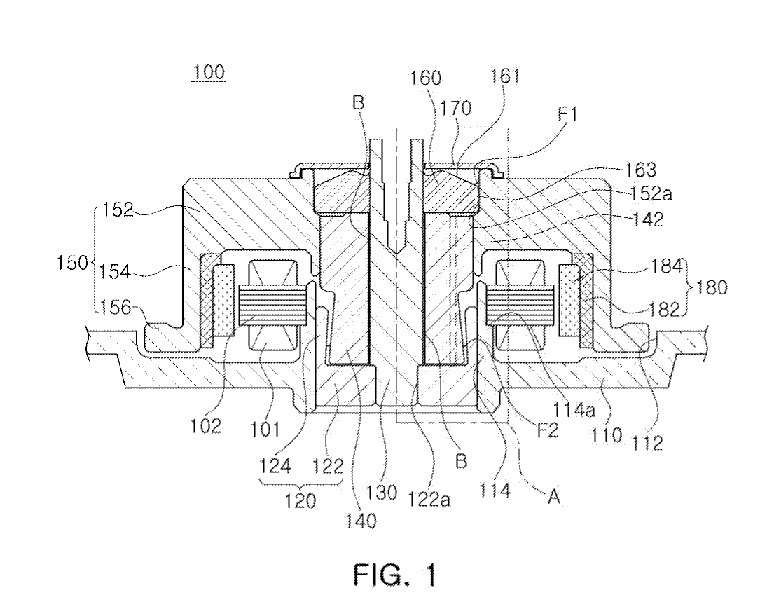

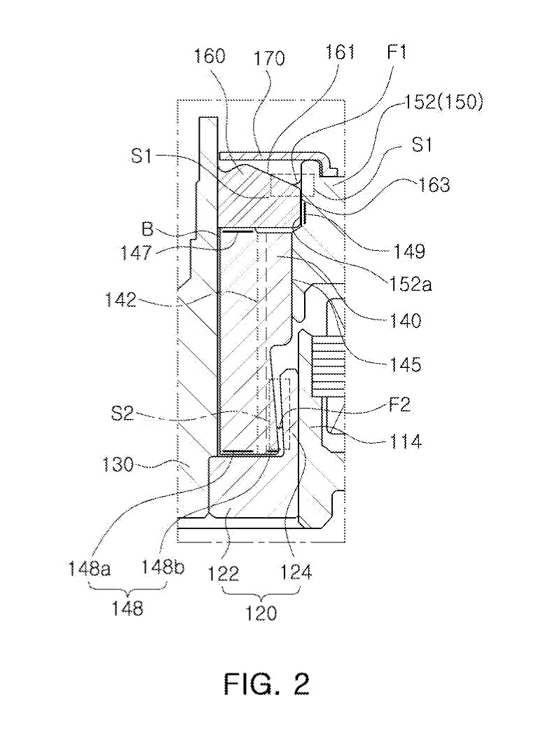

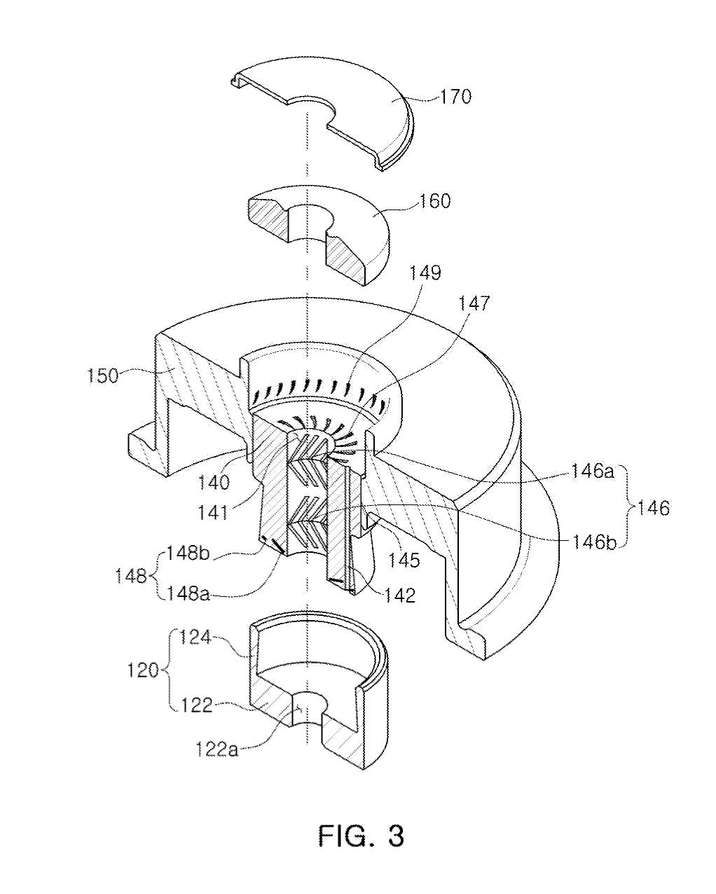

FIG. 1 is a schematic cross-sectional view showing a spindle motor according to an exemplary embodiment of the present disclosure; FIG. 2 is an enlarged view of part A of FIG. 1; and FIG. 3 is a partially cut-away exploded perspective view showing a sleeve and upper and lower thrust members according to an exemplary embodiment of the present disclosure.

Referring to FIGS. 1 through 3, a spindle motor 100 according to an exemplary embodiment of the present disclosure may include a base member 110, a lower thrust member 120, a shaft 130, a sleeve 140, a rotor hub 150, and an upper thrust member 160. In addition, the spindle motor 100 according to an exemplary embodiment of the present disclosure may further include a cap member 170 closing a sealing part S1 formed by the rotor hub 150 and the upper thrust member 160 above the sealing part S1.

The base member 110 may have a mounting groove 112 formed therein so as to form a predetermined space together with the rotor hub 150. In addition, the base member 110 may have a coupling part 114 extended in an upward axial direction and having a stator core 102 installed on an outer peripheral surface thereof.

In addition, the coupling part 114 may have a seating surface 114a provided on the outer peripheral surface thereof so that the stator core 102 may be seated and installed thereon. Further, the stator core 102 seated on the coupling part 114 may be disposed above the mounting groove 112 of the base member 110 described above.

The lower thrust member 120 may be fixed to the base member 110. That is, the lower thrust member 120 may be inserted into the coupling part 114. More specifically, the lower thrust member 120 may be installed so that an outer peripheral surface thereof is bonded to an inner peripheral surface of the coupling part 114.

Meanwhile, the lower thrust member 120 may include a disk part 122 having an inner surface fixed to the shaft 130 and an outer surface fixed to the base member 110 and an extension part 124 extended from the disk part 122 in the upward axial direction.

That is, the lower thrust member 120 may have a cup shape with a hollow part. That is, the lower thrust member 120 may have a ‘ [symbol] ’ shaped cross section.

In addition, the disk part 122 may be provided with an installation hole 122a in which the shaft 130 is installed, and the shaft 130 may be inserted into the installation hole 122a.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof, a radial direction refers to a horizontal direction, that is, a direction from the shaft 130 toward an outer peripheral surface of the rotor hub 150 or from the outer peripheral surface of the rotor hub 150 toward shaft 130, and a circumferential direction refers to a rotation direction along the outer peripheral surface of the rotor hub 150.

In addition, the lower thrust member 120 may be included, together with the base member 110, in a fixed member, that is, a stator.

Meanwhile, an outer surface of the lower thrust member 120 may be bonded to an inner surface of the base member 110 by an adhesive and/or welding. In other words, the outer surface of the lower thrust member 120 may be fixed and bonded to an inner surface of the coupling part 114 of the base member 110.

In addition, a thrust dynamic groove 148 for generating thrust fluid dynamic pressure may be formed in at least one of an upper surface of the lower thrust member 120 and a lower surface of the sleeve 140. A detailed description thereof will also be provided below with reference to FIGS. 2 and 3.

Further, the lower thrust member 120 may also serve as a sealing member for preventing a lubricating fluid from being leaked. A detailed description thereof will also be provided below with reference to FIGS. 2 and 3.

The shaft 130 may be fixed to at least one of the lower thrust member 120 and the base member 110. That is, the shaft 130 may be installed so that a lower end portion thereof is inserted into the installation hole 122a formed in the disk part 122 of the lower thrust member 120.

In addition, the lower end portion of the shaft 130 may be bonded to an inner surface of the disk part 122 by an adhesive and/or welding. Therefore, the shaft 130 may be fixed.

Although the case in which the shaft 130 is fixed to the lower thrust member 120 has been described by way of example in the present exemplary embodiment, the present disclosure is not limited thereto. That is, the shaft 130 may also be fixed to the base member 110.

Meanwhile, the shaft 130 may also be included, together with the lower thrust member 120 and the base member 110, in the fixed member, that is, the stator.

An upper surface of the shaft 130 may be provided with a coupling unit, for example, a screw part to which a screw is screwed, so that a cover member (not shown) may be fixed thereto.

The sleeve 140 may be rotatably installed on the shaft 130. To this end, the sleeve 140 may include a through-hole 141 into which the shaft 130 is inserted. Meanwhile, in the case in which the sleeve 140 is installed on the shaft 130, an inner peripheral surface of the sleeve 140 and an outer peripheral surface of the shaft 130 may be disposed so as to be spaced apart from each other by a predetermined interval to form a bearing clearance B therebetween. In addition, the bearing clearance B may be filled with a lubricating fluid.

The sleeve 140 may have the rotor hub 150 bonded to an outer peripheral surface thereof. That is, an outer surface of an upper portion of the sleeve 140 may have a shape corresponding to that of an inner surface of the rotor hub 150, such that the rotor hub 150 may be fixed thereto. That is, the sleeve 140 may have a bonding surface 145 formed on the outer surface thereof. Here, the sleeve 140 and the rotor hub 150 may be integrally formed with each other. In the case in which the sleeve 140 and the rotor hub 150 are integrally formed with each other, since both of the sleeve 140 and the rotor hub 150 are provided as a single member, the number of components may be decreased, whereby a product may be easily assembled.

Meanwhile, a lower end portion of the outer peripheral surface of the sleeve 140 may be inclined upwardly in an inner diameter direction so as to form a liquid-vapor interface together with the extension part 124 of the lower thrust member 120.

That is, the lower end portion of the sleeve 140 may be inclined upwardly in the inner diameter direction so that a second liquid-vapor interface F2 may be formed in a space between the outer surface of the sleeve 140 and the extension part 124 of the lower thrust member 120.

As described above, since the second liquid-vapor interface F2 is formed in the space between the lower end portion of the sleeve 140 and the extension part 124, the lubricating fluid filled in the bearing clearance B may form first and second liquid-vapor interfaces F1 and F2.

In addition, the sleeve 140 may have a dynamic groove 146 formed in an inner surface thereof in order to generate fluid dynamic pressure through the lubricating fluid filled in the bearing clearance B at the time of being rotated. That is, the dynamic groove 146 may include upper and lower dynamic grooves 146a and 146b, as shown in FIG. 3.

However, the dynamic groove 146 is not limited to being formed in the inner surface of the sleeve 140, but may also be formed in the outer peripheral surface of the shaft 130. In addition, the dynamic groove 146 may have various shapes such as a herringbone shape, a spiral shape, and the like.

In addition, the sleeve 140 may further include a circulation hole 142 formed therein so as to allow upper and lower surfaces thereof to be in communication with each other. The circulation hole 142 may discharge air bubbles contained in the lubricating fluid of the bearing clearance B to the outside and facilitate circulation of the lubricating fluid.

The rotor hub 150 may be coupled to the sleeve 140 to thereby be rotated together with the sleeve 140.

The rotor hub 150 may include a rotor hub body 152 provided with an insertion portion 152a into which the upper thrust member 160 is inserted, a mounting part 154 extended from an edge of the rotor hub body 152 in a downward axial direction and having a magnet assembly 180 mounted on an inner surface thereof in the radial direction, and an extension part 156 extended from a distal end of the mounting part 154 in an outer diameter direction.

Meanwhile, a lower end portion of an inner surface of the rotor hub body 152 may be bonded to the outer surface of the sleeve 140. That is, the lower end portion of the inner surface of the rotor hub body 152 may be bonded to the bonding surface 145 of the sleeve 140 by an adhesive and/or welding.

Therefore, the sleeve 140 may be rotated together with the rotor hub 150 at the time of rotation of the rotor hub 150. As described above, the sleeve 140 and the rotor hub 150 may be integrally formed with each other.

Meanwhile, the magnet assembly 180 may include a yoke 182 fixedly installed on the inner surface of the mounting part 154 and a magnet 184 installed on an inner peripheral surface of the yoke 182.

The yoke 182 may serve to direct a magnetic field from the magnet 184 toward the stator core 102 to increase a magnetic flux density. Meanwhile, the yoke 182 may have a circular ring shape or have a shape in which one end portion thereof is bent so as to increase the magnetic flux density by the magnetic field generated from the magnet 184.

The magnet 184 may have an annular ring shape, and may be a permanent magnet generating a magnetic field having a predetermined strength by alternately magnetizing an N pole and an S pole in the circumferential direction.

Meanwhile, the magnet 184 may be disposed so as to face a front end of the stator core 102 having a coil 101 wound therearound, and may electromagnetically interact with the stator core 102 having the coil 101 wound therearound to generate driving force capable of rotating the rotor hub 150.

That is, when power is supplied to the coil 101, the driving force capable of rotating the rotor hub 150 may be generated by the electromagnetic interaction between the stator core 102 having the coil 101 wound therearound and the magnet 184 disposed so as to face the stator core 102, such that the rotor hub 150 may be rotated together with the sleeve 140.

The upper thrust member 160 may be fixed to an upper end portion of the shaft 130, and may have a liquid-vapor interface F1 formed between a surface thereof facing the rotor hub 150 in the radial direction and the rotor hub 150. In addition, the upper thrust member 160 may be integrally formed with the shaft 130. In this case, a product may be easily manufactured, and the number of coupling holes may be decreased, such that a manufacturing yield of the product may be improved.

Further, the upper thrust member 160 may be inserted into a space formed by an upper end portion of the outer peripheral surface of the shaft 130, an upper surface of the sleeve 140, and the inner surface 152a of the rotor hub 150.

In addition, the upper thrust member 160, which also is a fixed member fixedly installed together with the base member 110, the lower thrust member 120, and the shaft 130, may be a member configuring the stator.

Meanwhile, since the upper thrust member 160 is fixed to the shaft 130 and the sleeve 140 is rotated together with the rotor hub 150, the first liquid-vapor interface F1 may be formed in a space between an inclined part 161 of the upper thrust member 160 and the inner surface 152a of the rotor hub 150. In addition, an upper sealing part S1 may be provided as a space in which the fluid is sealed in the space between the inclined part 161 of the upper thrust member 160 and the inner surface 152a of the rotor hub 150.

Further, an outer peripheral surface 163 of the upper thrust member 160 and the inner surface 152a of the rotor hub 150 disposed so as to face the outer peripheral surface 163 of the upper thrust member 160 may form a labyrinth seal. A lower portion 163 of the inclined part 161 of the upper thrust member 160 and the inner surface 152a of the rotor hub body 152 may be disposed so as to be spaced apart from each other by a predetermined interval to thereby be filled with the lubricating fluid, and may form the labyrinth seal so as to significantly decrease leakage of the lubricating fluid.

Therefore, in the case in which other impact such as external force, or the like, is present, the leakage of the lubricating fluid may be suppressed by suppressing the lubricating fluid from being easily moved to the outside.

Therefore, the outer peripheral surface of the upper thrust member 160 and the inner surface of the rotor hub body 152 may form a clearance of 0.3 mm or less therebetween.

In addition, an upper auxiliary pumping groove 149 may be formed in one of surfaces of the upper thrust member 160 and the rotor hub 150 facing each other in the radial direction. That is, the upper auxiliary pumping groove 149 may be formed in the surface of the upper thrust member 160 facing the rotor hub 150 in the radial direction or the surface of the rotor hub 150 facing the upper thrust member 160, and may pump the lubricating fluid in the downward axial direction when a rotating member is relatively rotated with respect to the fixed member. Pressure formed in the lubricating fluid by the upper auxiliary pumping groove 149 may be higher than pressure formed in the lubricating fluid by a lower auxiliary pumping groove 148b.

In this case, since the upper auxiliary pumping groove 149 is formed between the surfaces of the upper thrust member 160 and the rotor hub 150 facing each other in the radial direction, the upper auxiliary pumping groove 149 may be formed in surfaces of facing members in the radial direction between which an interval is constantly maintained even though the spindle motor is operated. Therefore, the pressure formed in the lubricating fluid formed by the upper auxiliary pumping groove 149 may be constant.

Meanwhile, a thrust dynamic groove 147 for generating thrust dynamic pressure may be formed in at least one of a lower surface of the upper thrust member 160 and the upper surface of the sleeve 140 disposed so as to face the lower surface of the upper thrust member 160. According to an exemplary embodiment of the present disclosure, the thrust dynamic groove 147 may include all types of thrust dynamic grooves formed in the radial direction in the case in which the circulation hole 142 is not formed in the sleeve 140. For example, the number of thrust dynamic grooves formed in the radial direction may be one or two or more. Meanwhile, according to an exemplary embodiment of the present disclosure, the thrust dynamic groove may mean only a thrust dynamic groove 148a formed at an inner portion of the circulation hole 142 in the radial direction in the case in which the circulation hole 142 is formed in the sleeve 140.

In addition, the upper thrust member 160 may also serve as a sealing member preventing the lubricating fluid filled in the bearing clearance B from being leaked upwardly.

Hereinafter, configurations of sealing parts, which are feature parts of the present disclosure, will be described in detail with reference to FIGS. 2 and 3.

Referring to FIGS. 2 and 3, in an exemplary embodiment of the present disclosure, a pair of sealing parts S1 and S2 may be provided at upper and lower portions. That is, the sleeve 140 may be disposed above the lower thrust member 120 to form, together with the lower thrust member 120, the liquid-vapor interface F2 of the lubricating fluid, thereby forming a lower sealing part S2. In addition, the rotor hub 150 may be disposed in an outer portion of the upper thrust member 160 in the radial direction to form, together with the upper thrust member 160, the liquid-vapor interface F1 of the lubricating fluid on the surface thereof facing the upper thrust member 160 in the radial direction, thereby forming an upper sealing part S1.

Here, in an exemplary embodiment of the present disclosure, a volume of the lubricating fluid may be larger in the lower sealing part S2 than in the upper sealing part S1. In the present disclosure, the sealing parts S1 and S2, parts at which the lubricating fluid and air meet each other, as represented by a box in FIG. 2, may mean parts in which the lubricating fluid is sealed by a capillary phenomenon.

Further, in an exemplary embodiment of the present disclosure, the lubricating fluid may be pumped to the lower sealing part S2 having the larger volume of the lubricating fluid, of the sealing parts S1 and S2, such that the leakage of the lubricating fluid may be prevented at the time of an operation of the spindle motor.

Therefore, in an exemplary embodiment of the present disclosure, the pressure formed in the lubricating fluid by the upper auxiliary dynamic groove 149 positioned adjacently to the upper sealing part S1 having a smaller volume of the lubricating fluid, of the upper and lower sealing parts S1 and S2 may be higher than pressure formed in the lubricating fluid by the lower auxiliary dynamic groove 148b positioned adjacently to the lower sealing part S2. This is to pump the lubricating fluid from the upper auxiliary dynamic groove 149 toward the lower auxiliary dynamic groove 148b when the spindle motor is operated, thereby allowing a larger amount of lubricating fluid to be stored in the lower sealing part S2 having the larger volume depending on a deviation of pumping force. Here, the dynamic groove may have various shapes such as a spiral shape, and the like.

To this end, in an exemplary embodiment of the present disclosure, a depth of the lower auxiliary dynamic groove 148b positioned adjacently to the lower sealing part S2 may be shallower than that of the upper auxiliary dynamic groove 149. When a depth of the dynamic groove is shallow, pressure formed in the dynamic groove may be strong, such that the dynamic groove may pump the lubricating fluid toward the sealing part having the larger volume.

Further, in an exemplary embodiment of the present disclosure, an interval between the lower thrust member 120 and the sleeve 140 in the axial direction may be larger than an interval between the upper thrust member 160 and the rotor hub 150 in the axial direction. That is, the narrow the interval between the rotating member and a member adjacent to the rotating member, the stronger the pumping force by the dynamic groove. Therefore, the lubricating fluid may be pumped toward the sealing part having the larger volume by adjusting an interval between members facing each other.

Meanwhile, in the case in which the sleeve 140 according to an exemplary embodiment of the present disclosure includes the circulation hole 142 formed therein so as to allow the upper and lower surfaces of the sleeve 140 to be in communication with each other, structures of the sleeve or the thrust member for pumping the lubricating fluid toward the sealing part having the larger volume may become different from each other.

That is, in the case in which the circulation hole 142 is formed, the thrust dynamic groove 148 may include the thrust dynamic groove 148a positioned at an inner portion of the circulation hole 142 in the radial direction and the lower auxiliary dynamic groove 148b positioned in an outer portion of the circulation hole 142 in the radial direction.

That is, upper pumping force and lower pressure formed in the lubricating fluid may become different from each other by the lower auxiliary dynamic groove 148b positioned at the outer portion of the circulation hole 142 in the radial direction. The thrust dynamic groove 148a positioned at the inner portion of the circulation hole 142 in the radial direction may be utilized in order to generate floating force of the rotating member or circulate the lubricating fluid rather than a difference between the upper pumping force and the lower pressure formed in the lubricating fluid. The present disclosure is not limited thereto, but may be variously utilized.

Therefore, the pressure formed in the lubricating fluid by the upper auxiliary pumping groove 149 positioned adjacently to the sealing part having the smaller volume of the lubricating fluid, of the upper and lower sealing parts S1 and S2 may be higher than pressure formed in the lubricating fluid by the lower auxiliary pumping groove 148b positioned adjacently to the other sealing part. In this case, the lubricating fluid may be pumped toward and stored in the sealing part having the larger volume.

In addition, the depth of the lower auxiliary dynamic groove 148b positioned adjacently to the sealing part having the larger volume of the lubricating fluid, of the upper and lower sealing parts S1 and S2, may be shallower than that of the thrust dynamic groove positioned adjacently to the other sealing part, thereby allowing the lubricating fluid to be pumped toward the sealing part having the larger volume.

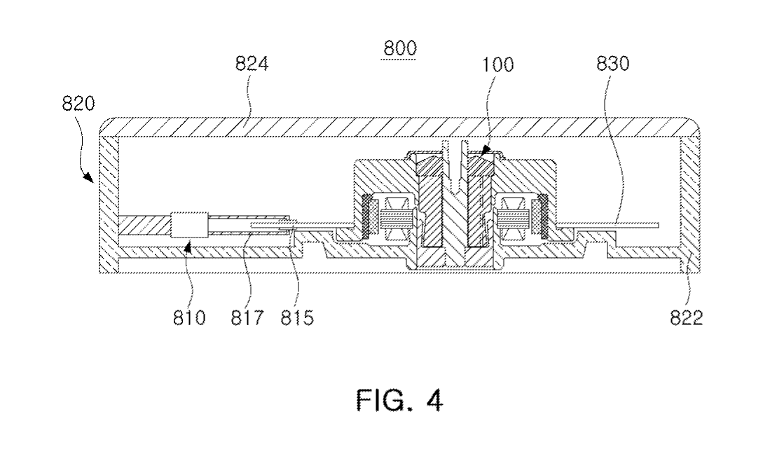

FIG. 4 is a schematic cross-sectional view showing a recording disk driving device having the spindle motor according to an exemplary embodiment of the present disclosure mounted therein.

Referring to FIG. 4, a recording disk driving device 800 having the spindle motor 100 according to an exemplary embodiment of the present disclosure mounted therein may be a hard disk drive, and may include the spindle motor 100, a head transfer part 810, and a housing 820.

The spindle motor 100 may have all features of the spindle motor according to an exemplary embodiment of the present disclosure described above and have a recording disk 830 mounted thereon.

The head transfer part 810 may transfer a head 815 detecting information of the recording disk 830 mounted in the spindle motor 100 to a surface of the recording disk of which the information is to be detected.

Here, the head 815 may be disposed on a support part 817 of the head transfer part 810.

The housing 820 may include a motor mounting plate 822 and a top cover 824 shielding an upper portion of the motor mounting plate 822 in order to form an internal space accommodating the spindle motor 100 and the head transfer part 810 therein.

As set forth above, according to exemplary embodiments of the present disclosure, the spindle motor including a sealing part having a volume in which a sufficient amount of lubricating fluid may be stored is provided, whereby deterioration of performance of a dynamic bearing assembly may be suppressed.

Therefore, the sufficient amount of lubricating fluid is continuously provided, whereby rotational characteristics of the spindle motor may be improved.

The present disclosure is not limited to having the above-mentioned effects, but may have various effects that may be implemented by exemplary embodiments of the present disclosure.

While exemplary embodiments have been shown and described above, it will be apparent to those skilled in the art that modifications and variations could be made without departing from the scope of the present invention as defined by the appended claims.

What is claimed is:

1. A spindle motor comprising:
a lower thrust member fixed to a base member;
a shaft fixed to at least one of the lower thrust member and the base member;
a sleeve disposed above the lower thrust member to form, together with the lower thrust member, a liquid-vapor interface of a lubricating fluid, thereby forming a lower sealing part, and rotatably installed on the shaft;
a rotor hub coupled to the sleeve to thereby be rotated together with the sleeve; and
an upper thrust member fixed to an upper end portion of the shaft and forming, together with the sleeve, a liquid-vapor interface of a lubricating fluid, thereby forming an upper sealing part,
wherein the sleeve includes a circulation hole formed therein so as to allow upper and lower surfaces thereof in an axial direction to be in communication with each other,
an upper auxiliary pumping groove is formed in any one of surfaces of the upper thrust member and the rotor hub facing each other in a radial direction,
a lower auxiliary pumping groove is formed in any one of surfaces of the lower thrust member and the sleeve facing each other in the axial direction, and
pressure formed in the lubricating fluid by the upper auxiliary pumping groove is higher than pressure formed in the lubricating fluid by the lower auxiliary pumping groove.

2. The spindle motor of claim 1, wherein a volume of the lubricating fluid is larger in the lower sealing part than in the upper sealing part.

3. The spindle motor of claim 1, wherein the lower auxiliary pumping groove is formed in an outer portion of the circulation hole in the radial direction.

4. The spindle motor of claim 1, wherein surfaces of the upper thrust member in which the upper auxiliary pumping groove is formed and the rotor hub, facing each other in the radial direction, have a labyrinth seal formed therebetween.

5. The spindle motor of claim 1, wherein a thrust dynamic groove is formed in at least one of a lower surface of the upper thrust member and the upper surface of the sleeve or at least one of an upper surface of the lower thrust member and the lower surface of the sleeve.

6. The spindle motor of claim 1, wherein the rotor hub includes:
a rotor hub body provided with an insertion portion into which the upper thrust member is inserted;
a mounting part extended from an edge of the rotor hub body and having a magnet assembly mounted on an inner surface thereof; and
an extension part extended from a distal end of the mounting part in an outer diameter direction.

7. The spindle motor of claim 1, wherein the sleeve and the rotor hub are integrally formed with each other.

8. The spindle motor of claim 1, wherein an outer surface, in the radial direction, of the sleeve facing the lower thrust member in the radial direction is inclined in an inner diameter direction upwardly in an axial direction.

9. The spindle motor of claim 4, wherein a portion above a portion at which the labyrinth seal is formed in an outer surface, in the radial direction, of the upper thrust member facing the rotor hub in the radial direction is inclined in an inner diameter direction upwardly in the axial direction.

10. The spindle motor of claim 1, wherein the shaft and the upper thrust member are integrally formed with each other.

11. The spindle motor of claim 1, wherein a depth of the upper auxiliary pumping groove is shallower than that of the lower auxiliary pumping groove.

12. The spindle motor of claim 1, wherein an interval between the surfaces of the upper thrust member and the rotor hub facing each other in the radial direction is smaller than an interval between the surfaces of the lower thrust member and the sleeve facing each other in the axial direction.

13. A hard disk drive comprising:
the spindle motor of claim 1 rotating a disk by power applied thereto through a substrate;
a magnetic head writing data to and reading data from the disk; and
a head transfer part moving the magnetic head to a predetermined position on the disk.
